(19) United States
(12) Patent Application Publication
(10) Pub. No.: US 2025/0111699 A1
(43) Pub. Date: Apr. 3, 2025

(54) IMAGE PROCESSING SYSTEM, IMAGE PROCESSING METHOD, AND COMPUTER-READABLE MEDIUM

(71) Applicant: NEC Corporation, Minato-ku, Tokyo (JP)

(72) Inventors: Jianquan LIU, Tokyo (JP); Noboru YOSHIDA, Tokyo (JP); Ryo KAWAI, Tokyo (JP)

(73) Assignee: NEC Corporation, Minato-ku, Tokyo (JP)

(21) Appl. No.: 18/834,659

(22) PCT Filed: Feb. 7, 2022
(86) PCT No.: PCT/JP2022/004681

§ 371 Date: Jul. 31, 2024

(51) Int. Cl. G06V 40/20

(52) U.S. Cl. CPC G06V 40/23; G06V 40/28

(57) ABSTRACT

An image processing system (10) includes an analysis means (11), a determination means (12), and a label assigning means (13). The analysis means (11) recognizes a plurality of motion images indicating a motion of a person from image data of motion images according to a plurality of consecutive frames obtained by capturing the person who performs a series of motions. The determination means (12) determines whether or not the motion image and a predetermined reference motion are related to each other. The label assigning means (13) assigns a label to at least some of the consecutive frames in the motion image based on the determination.

### TECHNICAL FIELD

The present disclosure relates to an image processing system, an image processing method, and a computer-readable medium.

### BACKGROUND ART

Techniques for classifying motions of persons included in image data have been developed.

For example, in the technique of Patent Literature 1, state information of a face and a hand of a target person is detected for a moving image obtained by capturing the target person, and the type of a motion of the target person is determined based on similarity between the state information and a motion model.

A person motion detection apparatus according to the technique of Patent Literature 2 generates a trajectory of a feature point as feature point trajectory information for each frame image of a video, and generates a trajectory feature amount by accumulating directions and sizes of movement vectors of the feature points for each range width obtained by dividing a possible range into a predetermined number. In addition, the person motion detection apparatus generates a distribution by accumulating clusters to which the trajectory feature amounts belong from a plurality of trajectory feature amounts within a predetermined time section, and compares the distribution with learning data to identify the motion of the person.

In the technique of Patent Literature 3, skeleton information based on a joint of a person is extracted in time series from video data, a surrounding area of the skeleton information is extracted, an action is recognized from the surrounding area of the video data, and an integrated score is output for each action.

### CITATION LIST

### Patent Literature

Patent Literature 1: Japanese Unexamined Patent Application Publication No. 2006-133937
Patent Literature 2: Japanese Unexamined Patent Application Publication No. 2012-088881
Patent Literature 3: Japanese Unexamined Patent Application Publication No. 2019-144830

### SUMMARY OF INVENTION

### Technical Problem

However, in the above-described techniques, even if an individual action can be recognized, processing for segmenting an image including a plurality of actions for each action cannot be performed.

In view of the aforementioned problems, an object of the present disclosure is to provide an image processing system and the like capable of efficiently performing processing for segmenting the motion of a person from an image captured by a camera.

### Solution to Problem

An image processing system according to an aspect of the present disclosure includes an analysis means, a determination means, and a label assigning means. The analysis means recognizes a plurality of motion images indicating a motion of a person from image data related to a plurality of consecutive frames obtained by capturing the person who performs a series of motions. The determination means determines whether or not each of the motion images and a predetermined reference motion are related to each other. The label assigning means assigns a label to at least some of the consecutive frames in the motion image based on the determination.

In an image processing method according to an aspect of the present disclosure, a computer executes the following processing. The computer recognizes a plurality of motion images indicating a motion of a person from image data related to a plurality of consecutive frames obtained by capturing the person who performs a series of motions. The computer determines whether or not each of the motion images and a predetermined reference motion are related to each other. The computer assigns a label to at least some of the consecutive frames in the motion image based on the determination.

A computer-readable medium according to an aspect of the present disclosure causes a computer to execute the following image processing method. The computer recognizes a plurality of motion images indicating a motion of a person from image data related to a plurality of consecutive frames obtained by capturing the person who performs a series of motions. The computer determines whether or not each of the motion images and a predetermined reference motion are related to each other. The computer assigns a label to at least some of the consecutive frames in the motion image based on the determination.

### Advantageous Effects of Invention

According to the present disclosure, it is possible to provide an image processing system and the like capable of efficiently performing processing for segmenting the motion of a person from an image captured by a camera.

### BRIEF DESCRIPTION OF DRAWINGS

FIG. 1 is a block diagram illustrating the configuration of an image processing system according to a first example embodiment.

FIG. 2 is a flowchart illustrating an image processing method according to the first example embodiment.

FIG. 3 is a diagram illustrating the overall configuration of an image processing system according to a second example embodiment.

FIG. 4 is a diagram illustrating skeleton data extracted from image data.

FIG. 5 is a diagram for explaining reference motion data according to the second example embodiment.

FIG. 6 is a diagram for explaining a first example of a reference motion according to the second example embodiment.

FIG. 7 is a diagram for explaining a second example of a reference motion according to the second example embodiment.

FIG. 8 is a diagram for explaining an example of label data.

FIG. 9 is a block diagram illustrating the overall configuration of an image processing system according to a third example embodiment.

FIG. 10 is a diagram for explaining skeleton data of an upper limb.

FIG. 11 is a flowchart illustrating an image processing method according to the third example embodiment.

FIG. 12 is a diagram for explaining reference motion data according to the third example embodiment.

FIG. 13 is a diagram illustrating a first example of an image including label data according to the third example embodiment.

FIG. 14 is a diagram illustrating a second example of an image including label data according to the third example embodiment.

FIG. 15 is a diagram illustrating a third example of an image including label data according to the third example embodiment.

FIG. 16 is a block diagram illustrating the hardware configuration of a computer.

### EXAMPLE EMBODIMENT

Hereinafter, the present disclosure will be described through example embodiments, but the disclosure according to the claims is not limited to the following example embodiments. In addition, not all the configurations described in the example embodiments are essential as means for solving the problem. In the diagrams, the same elements are denoted by the same reference numerals, and repeated description is omitted as necessary.

### First Example Embodiment

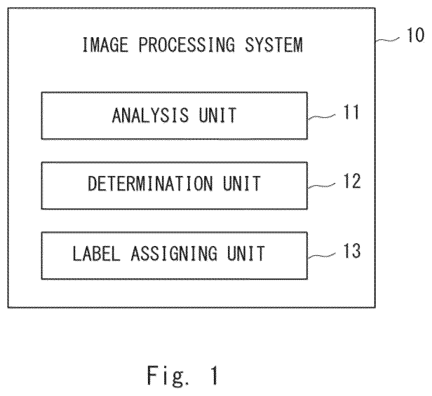

First, a first example embodiment of the present disclosure will be described. FIG. 1 is a block diagram illustrating the configuration of an image processing system 10 according to the first example embodiment. The image processing system 10 illustrated in FIG. 1 analyzes, for example, the posture or motion of a person included in an image captured by a camera, and assigns a label capable of classifying the motion of the person in the image. The image processing system 10 includes an analysis unit 11, a determination unit 12, and a label assigning unit 13 as main components. In addition, in the present disclosure, “posture” refers to a form in at least a part of a body, and “motion” refers to a state of taking a predetermined posture along time. The “motion” is not limited to a case where the posture changes, and includes a case where a constant posture is maintained. Therefore, simply referring to “motion” may include a posture.

The analysis unit 11 recognizes a plurality of motion images indicating the motion of the person from predetermined image data. The predetermined image data is image data according to a plurality of consecutive frames obtained by capturing a person performing a series of motions. The image data is, for example, image data according to a predetermined format such as H. 264 or H. 265. The series of motions may be any motion, but preferably includes predetermined postures or motions that can be classified. For example, the series of motions are predetermined work, dance, exercise, manners, and the like. The “motion image” is an image including information into which a motion of a person can be classified. That is, the motion image may be the image itself of the body of a person captured by a predetermined camera, or may be data of an image of the person captured by the camera subjected to trimming, brightness adjustment, enlargement, reduction, and the like. The motion image may be an image indicating the motion of the person estimated by analyzing the image of the person captured by the camera.

The analysis unit 11 recognizes skeleton data regarding the structure of the body of the person included in the predetermined image data as a motion image. Here, the skeleton data is data indicating the structure of the body of a person for detecting the posture or motion of the person, and includes a combination of a plurality of pseudo joint points and a pseudo skeleton structure.

The determination unit 12 determines whether or not the motion image recognized by the analysis unit 11 is related to a predetermined reference motion. Alternatively, the determination unit 12 can also determine that the motion indicated by each of the time-series sections in the image data is similar to the predetermined reference motion. At this time, the determination unit 12 uses reference skeleton data related to the reference motion for comparison with the skeleton data as a motion image. The reference skeleton data is skeleton data set in advance, and the image processing system 10 may have the reference skeleton data in advance, or the image processing system 10 may acquire the reference skeleton data from the outside.

The reference skeleton data is, for example, skeleton data extracted from predetermined reference image data. The reference image data for extracting skeleton data may be image data including an image of one frame, or may include images of a plurality of consecutive frames at a plurality of different times captured as a moving image. In addition, in the following description, an image for one frame may be referred to as a frame image or simply as a frame.

When determining whether or not the motion image and the reference motion are related to each other, the determination unit 12 calculates a similarity between skeleton data related to the motion image and predetermined reference skeleton data. For example, when the similarity is a predetermined value or more, the determination unit 12 determines that the recognized motion image and the reference motion are associated with each other. In addition, for example, when the similarity is less than the predetermined value, the determination unit 12 does not determine that the recognized motion image is associated with the reference motion.

In accordance with the determination made by the determination unit 12, the label assigning unit 13 assigns labels to at least some consecutive frames in the motion image. That is, the label assigning unit 13 generates label data corresponding to the motion image obtained by capturing a person who performs a series of motions. The label data is data set so that a predetermined reference motion can be segmented from the motion image. The label data is configured corresponding to the time series of the motion images. As a result, the image processing system 10 enables processing for segmenting a predetermined reference motion from the motion of the person included in the motion image. That is, the label assigning unit 13 assigns a label indicating the type of the motion indicated by the section to the section in the image data based on the determination of the determination unit 12.

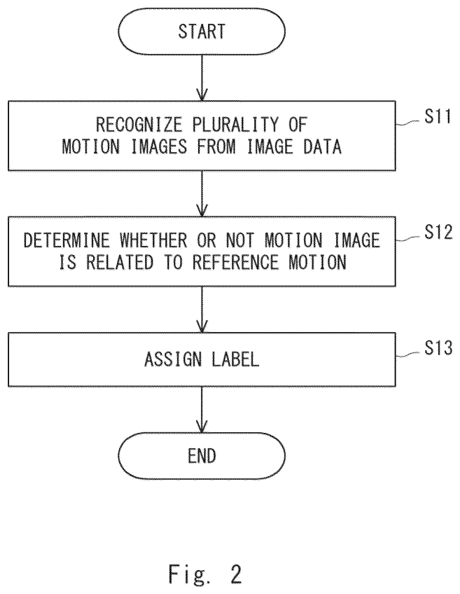

Next, processing of the image processing system 10 will be described with reference to FIG. 2. FIG. 2 is a flowchart illustrating a flow of an image processing method according to the first example embodiment. The flowchart illustrated in FIG. 2 is started when the image processing system 10 acquires image data, for example.

First, the analysis unit 11 recognizes a plurality of motion images indicating a motion of a person from image data of motion images according to a plurality of consecutive frames obtained by capturing the person who performs a series of motions (step S11). When recognizing the motion image, the analysis unit 11 supplies information about the recognized motion image to the determination unit 12.

Then, the determination unit 12 determines whether or not the motion image is related to the predetermined reference motion (step S12). More specifically, the determination unit 12 compares the motion of the person related to the motion image with the reference motion, and determines whether or not the motions are similar to each other. The determination unit 12 supplies information regarding a result of the determination to the label assigning unit 13.

Then, based on the determination made by the determination unit 12, the label assigning unit 13 assigns labels to at least some consecutive frames in the motion image (step S13). That is, the label assigning unit 13 assigns a label to the frame including the motion determined to be similar to the reference motion in the image data. When the label is assigned to the target frame in the image data by the label assigning unit 13, the image processing system 10 ends the series of processing.

Up to now, the first example embodiment has been described. In addition, the image processing system 10 includes a processor and a storage device as components (not illustrated). The storage device included in the image processing system 10 includes, for example, a storage device including a non-volatile memory such as a flash memory or a solid state drive (SSD). In this case, the storage device included in the image processing system 10 stores a computer program (hereinafter, also simply referred to as a program) for executing the above-described image processing method. In addition, the processor reads a computer program from the storage device into a buffer memory such as a dynamic random access memory (DRAM), and executes the program.

Each component included in the image processing system 10 may be implemented by dedicated hardware. In addition, some or all of the components may be implemented by general-purpose or dedicated circuitry, a processor, and the like, or a combination thereof. These may be implemented by a single chip or may be implemented by a plurality of chips connected to each other through a bus. Some or all of the components of each apparatus may be implemented by a combination of the above-described circuit and the like and a program. In addition, as the processor, a central processing unit (CPU), a graphics processing unit (GPU), a field-programmable gate array (FPGA), and the like can be used. In addition, the description regarding the configuration described herein can also be applied to other apparatuses or systems described below in the present disclosure.

In addition, when some or all of the components of the image processing system 10 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in the form of a client server system, a cloud computing system, or the like in which these are connected to each other through a communication network. In addition, the image processing method executed by the image processing system 10 may be provided in a software as a service (Saas) format. In addition, the above-described image processing method may be stored in a computer-readable medium to cause a computer to perform the method.

According to the present example embodiment, it is possible to provide an image processing system and the like capable of efficiently performing processing for segmenting the motion of a person from an image captured by a camera.

### Second Example Embodiment

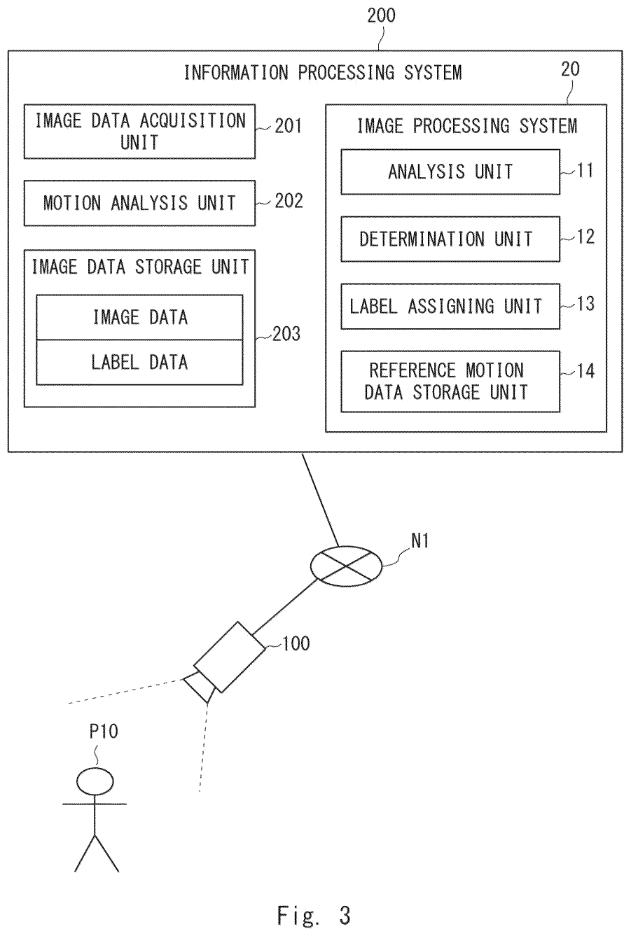

Next, a second example embodiment will be described. FIG. 3 is a diagram illustrating the overall configuration of an image processing system according to the second example embodiment. FIG. 3 illustrates a camera 100 and an information processing system 200. The camera 100 is installed so as to be able to capture the person P10. The camera 100 is connected to a network N1, and supplies image data of an image captured through the network N1 to the information processing system 200.

The information processing system 200 analyzes an image related to the motion of the person P10 included in the image data received from the camera 100. The information processing system 200 includes an image data acquisition unit 201, a motion analysis unit 202, an image data storage unit 203, and an image processing system 20 as main components.

The image data acquisition unit 201 acquires the image data supplied from the camera 100 and supplies the acquired image data to the image data storage unit 203. The motion analysis unit 202 analyzes image data labeled by the image processing system 20. Any processing may be performed by the motion analysis unit 202. The processing performed by the motion analysis unit 202 may be, for example, statistical processing such as counting the number of frames for an image including a preset type of motion. In addition, the information processing system 200 may include a display unit (not illustrated) to display an image related to motion analysis and present the image to the user. The motion analysis unit 202 may assist the user in analyzing the image data by displaying the image data and the data on the label assigned by the image processing system 20.

The image data storage unit 203 is a storage device including a non-volatile memory such as a flash memory, an SSD, or an HDD. The image data storage unit 203 receives the image data acquired by the image data acquisition unit 201 and stores the received image data. The image data storage unit 203 also stores data (label data) related to the label generated by the image processing system 20.

The image processing system 20 assigns a label to the image data in order to be able to segment the motion image related to the motion of the person in the image data acquired by the information processing system 200. The image processing system 20 is different from the image processing system 10 according to the first example embodiment in that the image processing system 20 includes a reference motion data storage unit 14.

The analysis unit 11 according to the present example embodiment extracts an image of the body of the person from the image data, and generates skeleton data regarding the structure of the body of the person from the extracted image data. As a result, the analysis unit 11 recognizes a motion image related to the motion of the person from the image data.

The determination unit 12 according to the present example embodiment determines whether or not the skeleton data related to the motion of the person is similar to the skeleton data as a reference motion by using the form of elements forming the skeleton data. When the motion image related to the motion of the person is similar to the skeleton data of the reference motion, the determination unit 12 determines that the motion image is related to the reference motion.

The label assigning unit 13 according to the present example embodiment assigns a label indicating being related to the reference motion to a frame related to the motion image related to the predetermined reference motion. More specifically, the label assigning unit 13 generates label data and supplies the generated label data to the image data storage unit 203.

The reference motion data storage unit 14 is an aspect of a storage means included in the image processing system 20, and stores a plurality of predetermined reference motions in an updatable manner. In this case, when the reference motion data is updated, the determination unit 12 performs the above determination using the updated data related to the reference motion.

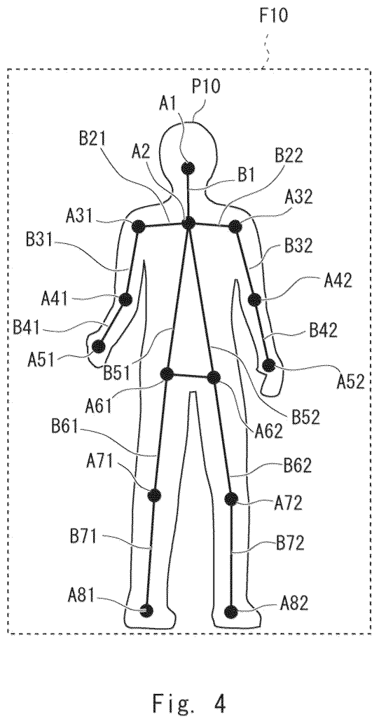

Next, an example of detecting the motion of a person will be described with reference to FIG. 4. FIG. 4 is a diagram illustrating skeleton data of the body extracted from image data. The image illustrated in FIG. 4 is a body image F10 obtained by extracting the body of the person P10 from the image captured by the camera 100. In the image processing system 10, the analysis unit 11 cuts out the body image F10 from the image captured by the camera 100, and sets a skeleton structure.

The analysis unit 11 extracts, for example, a feature point that can be a key point of the person P10 from the image. In addition, the analysis unit 11 detects key points from the extracted feature points. When detecting a key point, the analysis unit 11 refers to, for example, information obtained by machine learning for an image of the key point.

In the example illustrated in FIG. 4, the analysis unit 11 detects a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 as key points of the person P10.

In addition, the analysis unit 11 sets bones connecting these key points as a pseudo skeleton structure of the person P10 as follows. The bone B1 connects the head A1 and the neck A2 to each other. The bone B21 connects the neck A2 and the right shoulder A31 to each other, and the bone B22 connects the neck A2 and the left shoulder A32 to each other. The bone B31 connects the right shoulder A31 and the right elbow A41 to each other, and the bone B32 connects the left shoulder A32 and the left elbow A42 to each other. The bone B41 connects the right elbow A41 and the right hand A51 to each other, and the bone B42 connects the left elbow A42 and the left hand A52 to each other. The bone B51 connects the neck A2 and the right waist A61 to each other, and the bone B52 connects the neck A2 and the left waist A62 to each other. The bone B61 connects the right waist A61 and the right knee A71 to each other, and the bone B62 connects the left waist A62 and the left knee A72 to each other. Then, the bone B71 connects the right knee A71 and the right foot A81 to each other, and the bone B72 connects the left knee A72 and the left foot A82 to each other. After generating the skeleton data related to the above-described skeleton structure, the analysis unit 11 supplies the generated skeleton data to the determination unit 12.

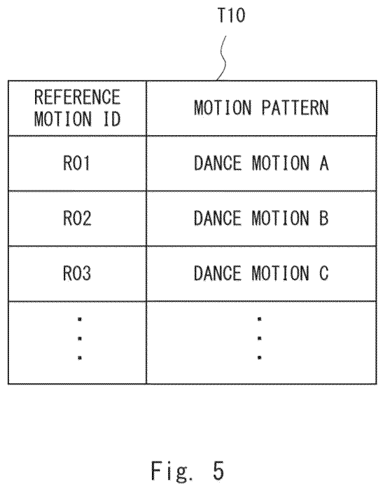

Next, an example of the reference motion data will be described with reference to FIG. 5. FIG. 5 is a diagram for explaining reference motion data according to the second example embodiment. In Table T10 illustrated in FIG. 5, a reference motion ID (identification, identifier) and skeleton data related to a plurality of motion patterns are associated with each other. Skeleton data related to a dance motion A corresponds to the reference motion ID (or motion ID) “R01”. Similarly, skeleton data corresponding to the reference motion ID “R02” is a dance motion B, and skeleton data corresponding to the reference motion ID “R03” is a dance motion C or the like.

As described above, the reference motion data is stored with the motion ID and the related word associated with each motion pattern. Each reference motion ID is associated with one or more pieces of skeleton data.

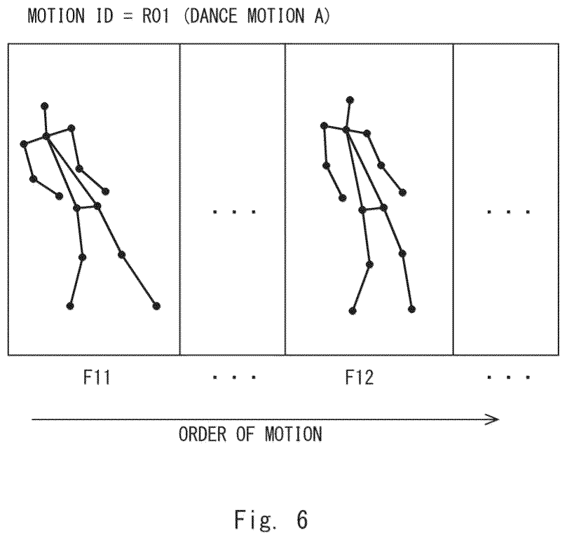

The skeleton data related to the reference motion will be described with reference to FIG. 6. FIG. 6 is a diagram for explaining a first example of a reference motion according to the second example embodiment. FIG. 6 illustrates the skeleton data of the dance motion A whose motion ID is “R01” among the reference motions included in the reference motion data. FIG. 6 illustrates a plurality of pieces of skeleton data including skeleton data F11 and skeleton data F12 in a state of being arranged in the left-right direction. The skeleton data F11 is located on the left side of the skeleton data F12. The skeleton data F11 is the motion of a person dancing a predetermined pattern, capturing the pattern change of the dance posture along a time series.

The motion pattern with the motion ID “R01” illustrated in FIG. 6 means that the person takes a posture corresponding to the skeleton data F11 and then takes a posture of the skeleton data F12. In addition, although two pieces of skeleton data have been described herein, the reference motion having a motion ID “R01” may include skeleton data other than the above-described skeleton data.

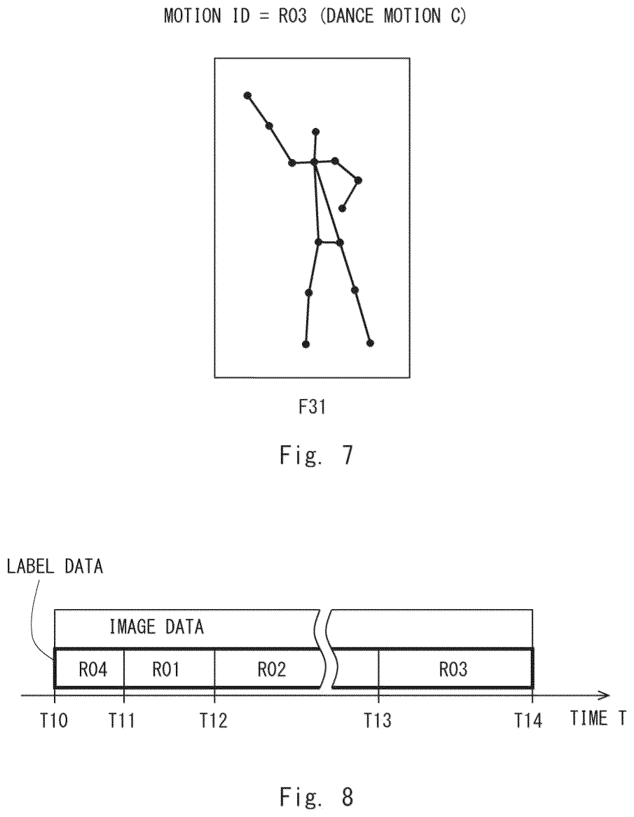

FIG. 7 is a diagram for explaining a second example of a reference motion according to the second example embodiment. FIG. 7 illustrates skeleton data F31 related to the motion having a motion ID “R03” illustrated in FIG. 5. In the reference motion having a motion ID “R03”, one piece of skeleton data F31 indicating a stationary posture is registered as the dance motion C.

As described above, the reference motion included in the reference motion data may include only one piece of skeleton data or may include two or more pieces of skeleton data. The determination unit 12 determines whether or not there is a similar reference motion by comparing the reference motion including the above-described skeleton data with the skeleton data of the motion image received from the analysis unit 11. The determination unit 12 also generates data indicating similarity for a motion image similar to the reference motion, and supplies the data to the label assigning unit 13.

Next, label data generated by the image processing system 20 will be described with reference to FIG. 8. FIG. 8 is a diagram for explaining an example of label data. FIG. 8 illustrates a time axis extending from the left side to the right side, band-shaped label data formed along the time axis, and band-shaped image data formed along the label data. In FIG. 8, label data and image data are illustrated in a band shape for easy description. However, each of the band-shaped label data and image data is data configured at a predetermined frame rate. Therefore, for example, in image data of 15 frames per second (15 fps), data regarding an image of one frame is configured every 1/15 seconds. In this case, as the label data, data related to a label corresponding to each frame is configured every 1/15 seconds.

The example illustrated in FIG. 8 illustrates a state in which a predetermined label is assigned to the image data from time T10 to time T14. That is, a label “R04” is assigned to the label data in a period from time T10 to time T11. Similarly, the label data is assigned a label “R01” in a period from time T11 to time T12, a motion ID R02 after time T12, and a label “R03” in a period from time T13 to time T14.

As described above, the label data includes at least data related to a time corresponding to the image data and data of a label to be assigned. The label data may be included in the image data or may be separate from the image data. The image processing system 20 generates label data corresponding to the image data so that the image data can be segmented according to the reference motion. That is, the user using the information processing system 200 can easily segment the image data by the label data when analyzing the motion of the person in the image data.

Although the second example embodiment has been described above, the image processing system 20 according to the second example embodiment is not limited to the above-described configuration. For example, the label assigning unit 13 may assign a plurality of types of labels to corresponding frames in the image data. This is, for example, a case where the determination unit 12 determines that one motion image is related to a plurality of types of reference motions. With such a configuration, the image processing system 20 can more flexibly perform image data segmentation.

In addition, the label assigning unit 13 may assign a label in a user-editable mode. The user-editable mode includes, for example, that the user can change the name of the label included in the label data illustrated in FIG. 8. In addition, the user-editable mode includes, for example, that the time serving as a boundary between the labels illustrated in FIG. 8 can be adjusted. The user-editable mode includes, for example, integrating adjacent labels or separating one label from a predetermined time as a boundary. As a result, the image processing system 20 can more efficiently perform image data segmentation.

According to the second example embodiment, it is possible to provide an image processing system and the like capable of efficiently performing processing for segmenting the motion of a person from an image captured by a camera.

### Third Example Embodiment

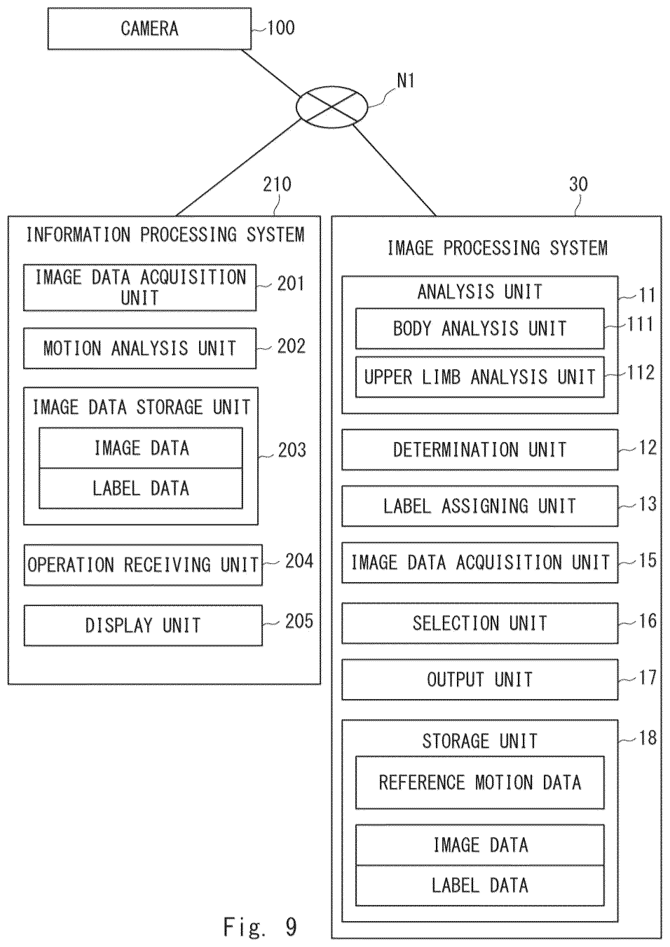

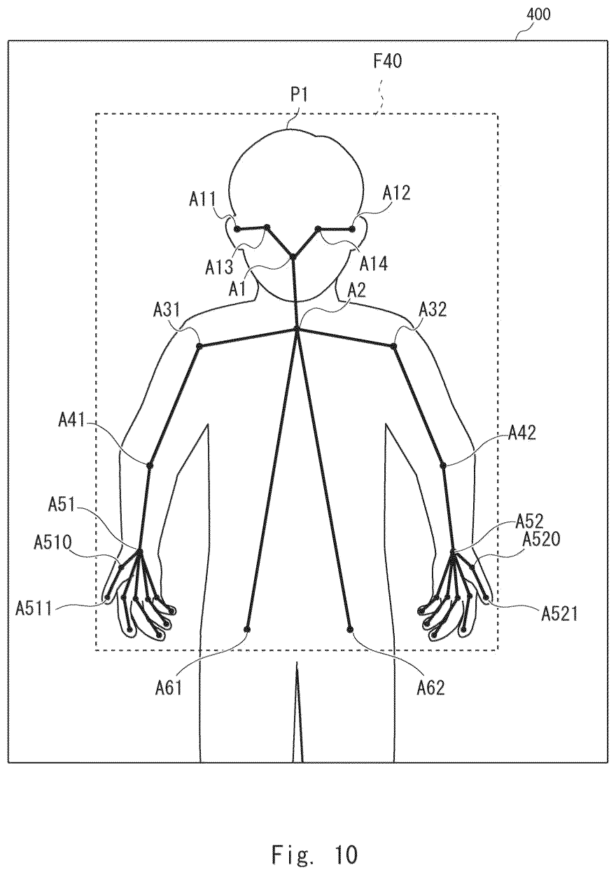

Next, a third example embodiment will be described. FIG. 9 is a block diagram illustrating the overall configuration of an image processing system according to the third example embodiment. In the third example embodiment, an information processing system and an image processing system are configured separately. In FIG. 9, an image processing system 30 and an information processing system 210 are communicably connected to each other through a network N1. In addition, in FIG. 9, a camera 100 installed so as to be able to capture the motion of a person is connected to the network N1.

Hereinafter, the image processing system 30 illustrated in FIG. 9 will be described. The image processing system 30 receives image data from the information processing system 210, generates label data by assigning a label to the received image data, and supplies the generated label data to the information processing system 210. The image processing system 30 includes an analysis unit 11, a determination unit 12, a label assigning unit 13, a reference motion data storage unit 14, an image data acquisition unit 15, a selection unit 16, an output unit 17, and a storage unit 18 as main components.

The analysis unit 11 according to the present example embodiment includes a body analysis unit 111 and an upper limb analysis unit 112. The body analysis unit 111 recognizes a body motion image from skeleton data regarding the structure of the body of the person extracted from the image data. That is, the body analysis unit 111 has the same function as the analysis unit 11 described in the second example embodiment.

The upper limb analysis unit 112 recognizes an upper limb motion image from the skeleton data of the upper limb including the movement of the finger of the person extracted from the image data. That is, the upper limb analysis unit 112 extracts the image of the upper limb of the person from the image data, estimates the pseudo skeleton of the upper limb including the movement of the finger of the person from the extracted image of the upper limb, and generates skeleton data corresponding to the estimated pseudo skeleton.

The determination unit 12 according to the present example embodiment determines the relevance of the reference motion corresponding to each of the above-described body motion image and upper limb motion image. In addition, the determination unit 12 may determine whether or not one or both of the body motion image and the upper limb motion image are included in the analysis target according to the setting of the user, and perform determination on the motion image of the determined part.

The image data acquisition unit 15 acquires the image data supplied from the information processing system 210. When the image data is received, the image data acquisition unit 15 supplies the received image data to the analysis unit 11.

The selection unit 16 selects a reference motion for assigning a label to a motion image related to the image data acquired from the reference motion data related to a plurality of reference motions. That is, the determination unit 12 according to the present example embodiment makes a determination using the selected reference motion. For example, the selection unit 16 selects a reference motion related to the body posture when the motion image analyzed by the analysis unit 11 relates to the body posture, and selects a reference motion related to the upper limb posture when the motion image analyzed by the analysis unit 11 relates to the upper limb posture. In addition, the selection unit 16 may select the received reference motion by receiving an operation of a user using the image processing system 30.

The output unit 17 outputs the label data generated by the label assigning unit 13. In the example illustrated in FIG. 9, the output unit 17 outputs the label data generated by the label assigning unit 13 to the information processing system 210 through the network N1.

The storage unit 18 includes a nonvolatile memory, and stores at least reference motion data. In addition, the storage unit 18 accumulates the image data acquired from the information processing system 210 and the label data generated by the label assigning unit 13. As a result, the image processing system 30 can accumulate data in a state in which segmentation processing on the image data received from the information processing system 210 is completed and output the data as a set of data.

Next, the information processing system 210 will be described. The information processing system 210 has a function of analyzing a motion image of a person included in the image data received from the camera 100. The information processing system 210 may be, for example, a personal computer, a tablet PC, a smartphone, or the like. The information processing system 210 includes an image data acquisition unit 201, a motion analysis unit 202, an image data storage unit 203, an operation receiving unit 204, and a display unit 205 as main components. Among these, the functions of the image data acquisition unit 201, the motion analysis unit 202, and the image data storage unit 203 are similar to those of the information processing system 200 according to the second example embodiment.

The operation receiving unit 204 is, for example, a keyboard, and receives an operation of a user who uses the information processing system 210. In addition, the operation receiving unit 204 may be a touch panel superimposed on the display unit 205 and set to interlock with the display unit 205. The display unit 205 includes a liquid crystal panel, organic electroluminescence, or the like, and displays and presents image data and label data to the user.

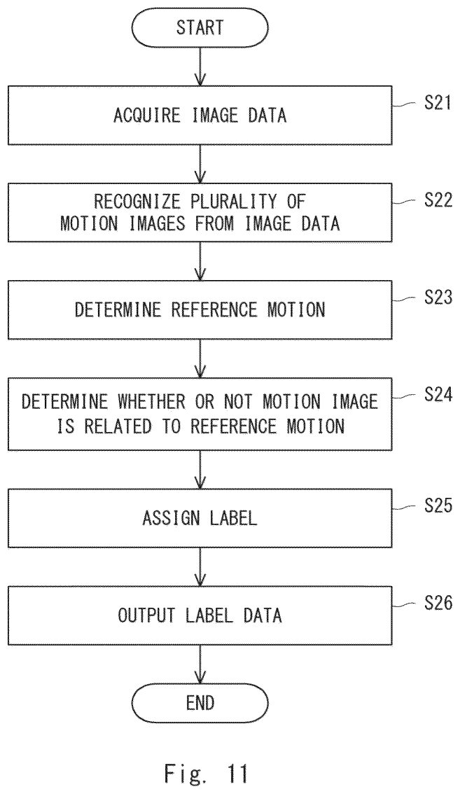

Next, skeleton data of the upper limb will be described with reference to FIG. 10. FIG. 10 is a diagram for explaining skeleton data of the upper limb. The image illustrated in FIG. 10 is an upper limb image F40 obtained by extracting the upper limb of the person P10 from the image 400 captured by the camera 100. In the image processing system 30, the upper limb analysis unit 112 cuts out the body image F40 from the image captured by the camera 100, and sets a skeleton structure.

The upper limb analysis unit 112 extracts feature points that can be key points of the person P10 from the image, and detects the key points from the extracted feature points. At this time, the upper limb analysis unit 112 extracts more key points of the head or the fingers than the analysis unit 11 illustrated in FIG. 4, for example. For example, the upper limb analysis unit 112 detects a right ear A11, a left ear A12, a right eye A13, and a left eye A14 on the head of the person P10. The upper limb analysis unit 112 detects, for example, a first joint A510 of the right thumb and a second joint A511 of the right thumb on the right hand of the person P10. Similarly, the upper limb analysis unit 112 detects, for example, a first joint A520 of the left thumb and a second joint A521 of the left thumb on the left hand of the person P10.

In this manner, the upper limb analysis unit 112 detects the key points of the fingers in more detail. As a result, the image processing system 30 can perform segmentation by the movement of the finger in the motion performed by the person P10.

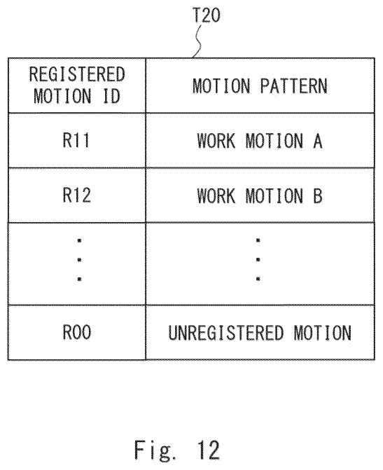

Next, processing executed by the image processing system 30 according to the present example embodiment will be described with reference to FIG. 11. FIG. 11 is a flowchart illustrating an image processing method according to the third example embodiment.

In the image processing system 30, the image data acquisition unit 15 acquires image data from the information processing system 210 (step S21). The image data acquisition unit 15 supplies the acquired image data to the analysis unit 11.

Then, the analysis unit 11 recognizes a plurality of motion images from the received image data (step S22). Here, the analysis unit 11 extracts an image of a person from the image data. The analysis unit 11 recognizes whether or not the extracted image is an image of the entire body of the person or an image of the upper limb. Then, the analysis unit 11 generates skeleton data for the recognized image.

Then, the selection unit 16 determines a reference motion for assigning a label from the skeleton data generated by the analysis unit 11 (step S23). When the reference motion is determined by the selection unit 16, the selection unit 16 notifies the determination unit 12 of the determined content. The content notified by the selection unit 16 is, for example, a signal indicating skeleton data related to the reference motion.

Then, according to the signal received from the selection unit 16, the determination unit 12 determines whether or not the skeleton data generated from the motion image by the analysis unit 11 is related to the reference motion by referring to the reference motion (step S24).

Then, the label assigning unit 13 assigns a label to the image data according to the processing of the determination unit 12 (step S25). The label assigning unit 13 stores label data related to the label assigned to the image data in the storage unit 18.

Then, the output unit 17 outputs the label data stored in the storage unit 18 to the information processing system 210 (step S26).

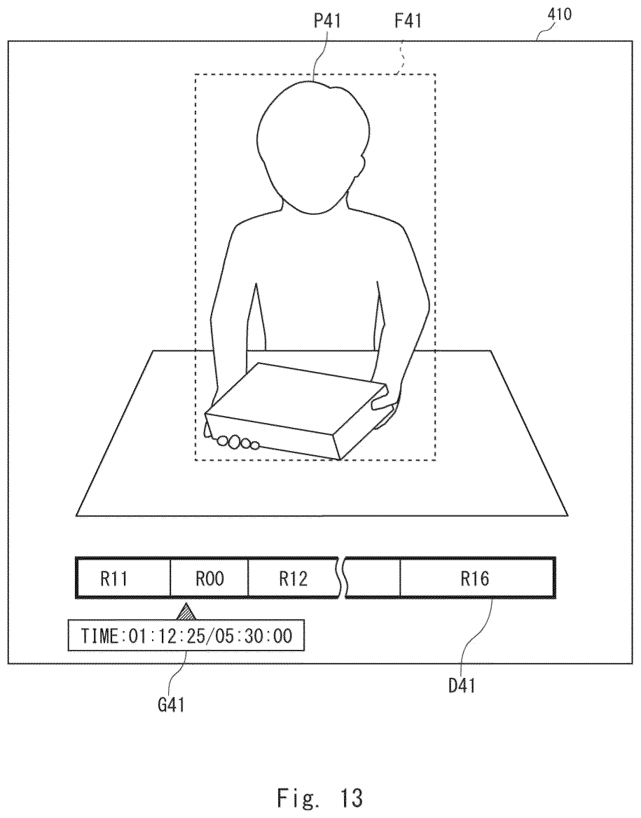

Then, the reference motion data according to the present example embodiment will be described. FIG. 12 is a diagram for explaining reference motion data according to the third example embodiment. Table T20 illustrated in FIG. 12 is reference motion data related to a predetermined work motion performed by a person. For example, a registered motion ID “R11” is skeleton data related to the motion pattern of the work motion A. In addition, a registered motion ID “R12” is skeleton data related to the motion pattern of the work motion B.

Table T20 illustrated in FIG. 12 is different from Table T10 illustrated in FIG. 5 in that the registered motion ID includes an “unregistered motion” as “R00” in the reference motion data. When referring to the reference motion according to Table T20, the image processing system 30 associates a motion image that is not similar to the registered motion pattern with “R00”. That is, the label assigning unit 13 can assign a label indicating an unregistered motion to a motion that is not similar to any reference motion. As a result, the user of the image processing system 30 can appropriately grasp the undefined motion included in the motion image. With such a configuration, the image processing system 30 can also perform the segmentation processing on the motion image that does not include the registered motion pattern.

Next, an example of an image showing label data to a user will be described with reference to FIG. 13. FIG. 13 is a diagram illustrating a first example of an image including label data according to the third example embodiment. An image 410 illustrated in FIG. 13 includes an image F41 of a person P41 who performs a predetermined work and label data D41 assigned by the image processing system 30. The label data D41 is a band-shaped display extending in the horizontal direction of the screen. The label data D41 indicates the passage of time from the left side to the right side, and the labels assigned to the motion of the person P41 are displayed as “R11”, “R00”, “R12”, and “R16” with the passage of time.

Below the label data D41, an indicator G41 indicating the passage of time is illustrated. In the indicator G41, an upper convex portion moves in the horizontal direction of the screen, and the tip portion indicates the passage of time of the label data. In the indicator G41, elapsed time information is displayed in the lower portion. With the above-described display, the motion image of the person P41 performing a work motion and the label data D41 are displayed in association with each other in the image 410. With such a display, the image processing system 30 can present the motion image and the label data to the user in association with each other.

As described above, the label assigning unit 13 assigns, to a frame related to the motion image related to a predetermined reference motion, a label indicating being related to the reference motion. On the other hand, the label assigning unit 13 assigns a label indicating being not related to the reference motion to a frame related to the motion image that is not related to any reference motion. The user who visually recognizes the image 410 can analyze the motion performed by the person P41 using the image 410. For example, the user can grasp how long each motion corresponding to the registered motion ID has been performed. In addition, the user can grasp a period of “R00” not corresponding to the registered motion ID and grasp what the person P41 is doing during the period.

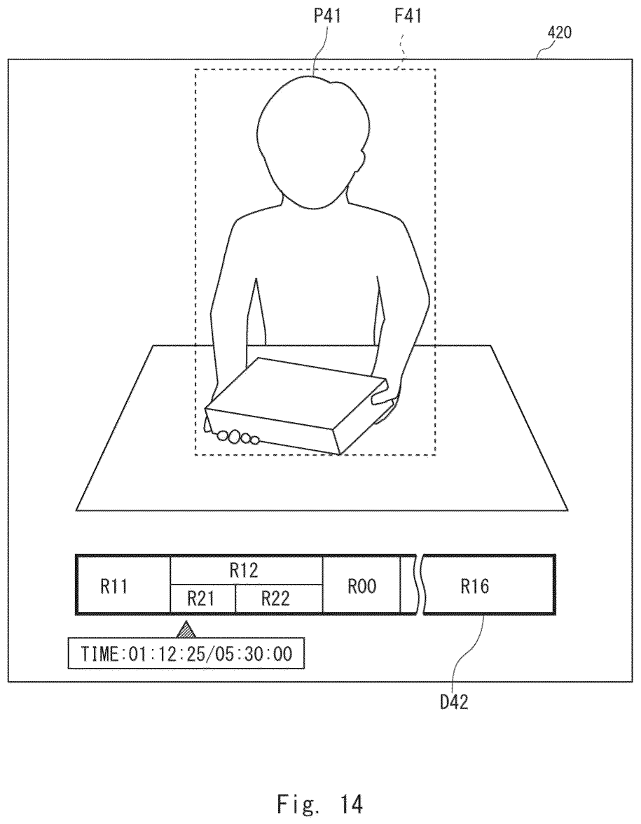

Next, a further example of the label data will be described with reference to FIG. 14. FIG. 14 is a diagram illustrating a second example of an image including label data according to the third example embodiment. An image 420 illustrated in FIG. 14 is different from FIG. 13 in label data. In label data D42 in the image 420, for example, “R12” and “R21” are displayed in the label data corresponding to the same time.

When the determination unit 12 indicates that one motion image and a plurality of types of reference motions are related to each other, the label assigning unit 13 assigns a plurality of types of labels to corresponding frames in the image data. Therefore, in the label data D42, a plurality of corresponding labels are displayed in a period in which a plurality of labels are assigned. As a result, for example, the image processing system 30 can segment the reference motion of the right hand finger and the reference motion of the left hand finger. Alternatively, the image processing system 30 can flexibly assign a label to a motion image similar to a plurality of motion patterns.

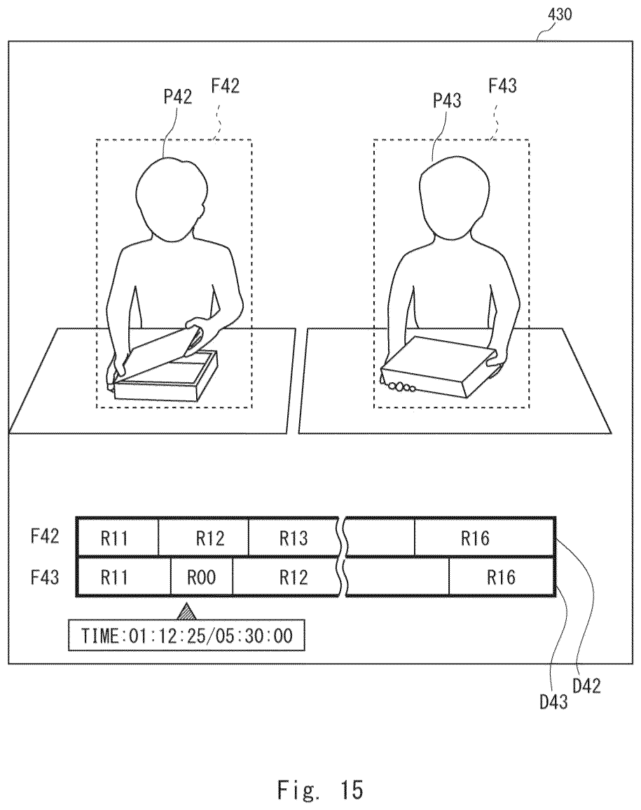

A further example of the label data will be described with reference to FIG. 15. FIG. 15 is a diagram illustrating a third example of an image including label data according to the third example embodiment. An image 430 illustrated in FIG. 15 includes an image F42 of a person P42 who performs predetermined work and an image F43 of a person P43 who performs predetermined work next to the person P42. In addition, the image 430 includes, as label data assigned by the image processing system 30, label data D42 corresponding to the image F42 and label data D43 corresponding to the image F43.

As described above, when the motion image includes a plurality of persons, the image processing system 30 causes the analysis unit 11 to extract a body image or an upper limb image for each of the plurality of persons, and generates skeleton data for each extracted image. Then, the determination unit 12 determines a relationship with the reference motion for each piece of extracted skeleton data, and the label assigning unit 13 generates label data for each piece of extracted skeleton data. As a result, the user of the image processing system 30 can analyze the motions of the plurality of persons while comparing the motions.

Up to now, the third example embodiment has been described. According to the third example embodiment, it is possible to provide an image processing system and the like capable of efficiently performing processing for segmenting the motion of a person from an image captured by a camera.

### <Example of Hardware Configuration>

Hereinafter, a case where each functional component of the determination apparatus in the present disclosure is implemented by a combination of hardware and software will be described.

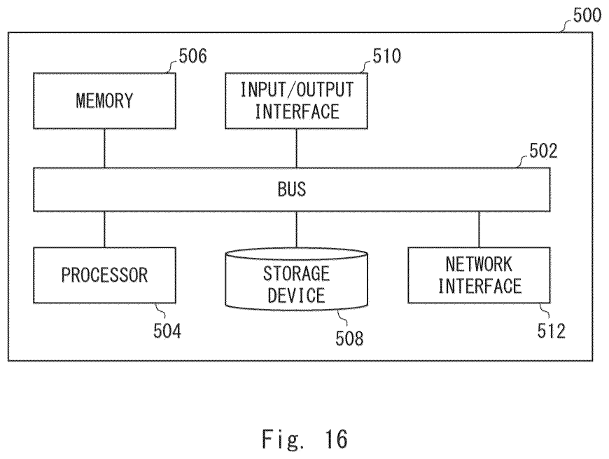

FIG. 16 is a block diagram illustrating the hardware configuration of a computer. The determination apparatus in the present disclosure can implement the above-described functions using a computer 500 having the hardware configuration illustrated in the diagram. The computer 500 may be a portable computer such as a smartphone or a tablet terminal, or may be a stationary computer such as a PC. The computer 500 may be a dedicated computer designed to implement each apparatus, or may be a general-purpose computer. The computer 500 can implement a desired function by installing a predetermined application.

The computer 500 includes a bus 502, a processor 504, a memory 506, a storage device 508, an input/output interface 510 (an interface is also referred to as an I/F (interface)), and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is various processors such as a CPU, a GPU, or an FPGA. The memory 506 is a main storage device implemented by using a random access memory (RAM) or the like.

The storage device 508 is an auxiliary storage device implemented by using a hard disk, an SSD, a memory card, a read only memory (ROM), or the like. The storage device 508 stores a program for implementing a desired function. The processor 504 reads the program to the memory 506 and executes the program to implement each functional component of each apparatus.

The input/output interface 510 is an interface for connecting the computer 500 and an input/output apparatus to each other. For example, an input apparatus such as a keyboard and an output apparatus such as a display device are connected to the input/output interface 510.

The network interface 512 is an interface for connecting the computer 500 to a network.

Although the example of the hardware configuration in the present disclosure has been described above, the above-described example embodiment is not limited thereto. The present disclosure can also be implemented by causing a processor to execute a computer program.

In the above-described example, the program includes a group of instructions (or software code) for causing a computer to perform one or more functions described in the example embodiments when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, transitory computer-readable or communication media include electrical, optical, acoustic, or other forms of propagated signals.

Although the example embodiments have been described above, the configurations of the above-described example embodiments may be combined with each other or some configurations may be replaced with other configurations. In addition, various modifications may be made to the configurations of the above-described example embodiments within the scope not departing from the gist. In addition, in the flowchart used in the above description, the execution order of the steps executed in each example embodiment can be changed within a range not hindering the function implemented by the example embodiment.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above example embodiments may be described as the following supplementary notes, but are not limited to the following.

### Supplementary Note 1

An image processing system including:
an analysis means for recognizing a plurality of motion images indicating a motion of a person from image data of motion images related to a plurality of consecutive frames obtained by capturing the person who performs a series of motions;
a determination means for determining whether or not each of the motion images and a predetermined reference motion are related to each other; and
a label assigning means for assigning a label to at least some of the consecutive frames in the motion image based on the determination.

### Supplementary Note 2

The image processing system according to Supplementary Note 1, wherein the analysis means recognizes the motion image from skeleton data regarding a structure of a body of a person extracted from the image data.

### Supplementary Note 3

The image processing system according to Supplementary Note 1, wherein the analysis means recognizes the motion image from skeleton data including a movement of a finger of a person extracted from the image data.

### Supplementary Note 4

The image processing system according to Supplementary Note 2 or 3, wherein when the skeleton data related to the motion is similar to the skeleton data as the reference motion based on a form of elements forming the skeleton data, the determination means performs the determination that the motion image is related to the reference motion.

### Supplementary Note 5

The image processing system according to Supplementary Note 1, wherein the analysis means includes:
a body analysis means for recognizing a body motion image from skeleton data regarding a structure of a body of a person extracted from the image data; and
an upper limb analysis means for recognizing an upper limb motion image from skeleton data of an upper limb including a movement of a finger of a person extracted from the image data, and
the determination means performs the determination on relevance of the reference motion corresponding to each of the body motion image and the upper limb motion image.

### Supplementary Note 6

The image processing system according to Supplementary Note 5, wherein the determination means determines whether or not one or both of the body motion image and the upper limb motion image are included in an analysis target according to a setting of a user, and performs the determination based on an image of a motion of the determined part.

### Supplementary Note 7

The image processing system according to any one of Supplementary Notes 1 to 6, wherein the analysis means recognizes the motion image for each person when the image data includes a plurality of persons.

### Supplementary Note 8

The image processing system according to any one of Supplementary Notes 1 to 7, wherein the label assigning means assigns the label indicating being related to the reference motion to the frame related to the motion image related to the predetermined reference motion.

### Supplementary Note 9

The image processing system according to Supplementary Note 8, wherein the label assigning means assigns the label indicating being not related to the reference motion to the frame related to the motion image that is not related to any of the reference motions.

### Supplementary Note 10

The image processing system according to any one of Supplementary Notes 1 to 9, wherein when the determination indicates that one of the motion images and a plurality of types of the reference motions are related to each other, the label assigning means assigns a plurality of types of the labels to the corresponding frames in the image data.

### Supplementary Note 11

The image processing system according to any one of Supplementary Notes 1 to 10, wherein the label assigning means assigns the label in a user-editable manner.

### Supplementary Note 12

The image processing system according to any one of Supplementary Notes 1 to 11, further including: a storage means for storing a plurality of the predetermined reference motions in an updatable manner,
wherein the determination means performs the determination based on the updated reference motion.

### Supplementary Note 13

The image processing system according to any one of Supplementary Notes 1 to 11, further including: a selection means for selecting the reference motion for assigning the label to the motion image from motion data related to a plurality of the reference motions,
wherein the determination means performs the determination based on the selected reference motion.

### Supplementary Note 14

An image processing method
causing a computer to execute:
recognizing a plurality of motion images indicating a motion of a person from image data of motion images related to a plurality of consecutive frames obtained by capturing the person who performs a series of motions;
determining whether or not each of the motion images and a predetermined reference motion are related to each other; and
assigning a label to at least some of the consecutive frames in the motion image based on the determination.

### Supplementary Note 15

A non-transitory computer-readable medium storing a program for causing a computer to execute an image processing method including:
recognizing a plurality of motion images indicating a motion of a person from image data related to a plurality of consecutive frames obtained by capturing the person who performs a series of motions;
determining whether or not each of the motion images and a predetermined reference motion are related to each other; and
assigning a label to at least some of the consecutive frames in the motion image based on the determination.

### Supplementary Note 16

An image processing system including:
an image data acquisition means for acquiring image data of an image obtained by capturing a person who performs a series of motions;
a determination means for determining that a motion indicated by each of time-series sections in the image data is similar to a predetermined reference motion; and
a label assigning means for assigning a label indicating a type of a motion indicated by the section to the section in the image data based on the determination.

### REFERENCE SIGNS LIST

10 IMAGE PROCESSING SYSTEM
20 IMAGE PROCESSING SYSTEM
30 IMAGE PROCESSING SYSTEM
11 ANALYSIS UNIT
12 DETERMINATION UNIT
13 LABEL ASSIGNING UNIT
14 REFERENCE MOTION DATA STORAGE UNIT
15 IMAGE DATA ACQUISITION UNIT
16 SELECTION UNIT
17 OUTPUT UNIT
18 STORAGE UNIT
100 CAMERA
111 BODY ANALYSIS UNIT
112 UPPER LIMB ANALYSIS UNIT
200 INFORMATION PROCESSING SYSTEM
201 IMAGE DATA ACQUISITION UNIT
202 MOTION ANALYSIS UNIT
203 IMAGE DATA STORAGE UNIT
204 OPERATION RECEIVING UNIT
205 DISPLAY UNIT
210 INFORMATION PROCESSING SYSTEM
500 COMPUTER
504 PROCESSOR
506 MEMORY
508 STORAGE DEVICE
510 INPUT/OUTPUT INTERFACE
512 NETWORK INTERFACE
N1 NETWORK

What is claimed is:

1. An image processing system comprising:
at least one memory storing instructions; and
at least one processor executing the instructions to:
recognize a plurality of motion images indicating a motion of a person from image data related to a plurality of consecutive frames obtained by capturing the person who performs a series of motions;
determine whether or not each of the motion images and a predetermined reference motion are related to each other; and
assign a label to at least some of the consecutive frames in the motion image based on the determination.

2. The image processing system according to claim 1, wherein the processor is configured to execute instruction to recognize the motion image from skeleton data regarding a structure of a body of a person extracted from the image data.

3. The image processing system according to claim 1, wherein the processor is configured to execute instruction to recognize the motion image from skeleton data including a movement of a finger of a person extracted from the image data.

4. The image processing system according to claim 2, wherein when the skeleton data related to the motion is similar to the skeleton data as the reference motion based on a form of elements forming the skeleton data, the processor is configured to execute instruction to perform the determination that the motion image is related to the reference motion.

5. The image processing system according to claim 1, wherein
the processor is configured to execute instructions to:
recognize a body motion image from skeleton data regarding a structure of a body of a person extracted from the image data; and
recognize an upper limb motion image from skeleton data of an upper limb including a movement of a finger of a person extracted from the image data, and
perform the determination on relevance of the reference motion corresponding to each of the body motion image and the upper limb motion image.

6. The image processing system according to claim 5, wherein the processor is configured to execute instructions to determine whether or not one or both of the body motion image and the upper limb motion image are included in an analysis target according to a setting of a user, and perform the determination based on an image of a motion of the determined part.

7. The image processing system according to claim 1, wherein the processor is configured to execute instruction to recognize the motion image for each person when the image data includes a plurality of persons.

8. The image processing system according to claim 1, wherein the processor is configured to execute instruction to assign the label indicating being related to the reference motion to the frame related to the motion image related to the predetermined reference motion.

9. The image processing system according to claim 8, wherein the processor is configured to execute instruction to assign the label indicating being not related to the reference motion to the frame related to the motion image that is not related to any of the reference motions.

10. The image processing system according to claim 1, wherein when the determination indicates that one of the motion images and a plurality of types of the reference motions are related to each other, the processor is configured to execute instruction to assign a plurality of types of the labels to the corresponding frames in the image data.

11. The image processing system according to claim 1, wherein the processor is configured to execute instruction to assign the label in a user-editable manner.

12. The image processing system according to claim 1, the memory further stores a plurality of the predetermined reference motions in an updatable manner,
wherein the processor is configured to execute instruction to perform the determination based on the updated reference motion.

13. The image processing system according to claim 1, the processor is further configured to execute instructions to select the reference motion for assigning the label to the motion image from motion data related to a plurality of the reference motions; and
perform the determination based on the selected reference motion.

14. An image processing method
causing a computer to execute:
recognizing a plurality of motion images indicating a motion of a person from image data related to a plurality of consecutive frames obtained by capturing the person who performs a series of motions;
determining whether or not each of the motion images and a predetermined reference motion are related to each other; and
assigning a label to at least some of the consecutive frames in the motion image based on the determination.

15. A non-transitory computer-readable medium storing a program for causing a computer to execute an image processing method including:
recognizing a plurality of motion images indicating a motion of a person from image data related to a plurality of consecutive frames obtained by capturing the person who performs a series of motions;
determining whether or not each of the motion images and a predetermined reference motion are related to each other; and
assigning a label to at least some of the consecutive frames in the motion image based on the determination.
